(19) United States
(12) Patent Application Publication
(10) Pub. No.: US 2026/0285434 A1
(43) Pub. Date: Sep. 24, 2026

(54) HOLDER

(71) Applicant: ABUS August Bremicker Söhne KG, Wetter-Volmarstein (DE)

(72) Inventor: Thomas Müller, Bischoffen (DE)

(21) Appl. No.: 19/558,858

(22) Filed: Mar. 6, 2026

(30) Foreign Application Priority Data
Mar. 18, 2025 (DE) 10 2025 110415.8

(51) Int. Cl. B62J 11/00; B62H 5/14

(52) U.S. Cl. CPC B62J 11/00; B62H 5/14

(57) ABSTRACT

A holder for a two-wheeler accessory, in particular for a two-wheeler lock, comprises a base body by which a contact surface is defined, said contact surface being bounded by two opposite longitudinal sides with respect to a transverse direction and being contacted by the two-wheeler accessory when it is received in the holder, and one or more pivot clips that are each adjustable between a releasing state and a securing state in order, in a releasing state, to enable a receiving of the two-wheeler accessory in the holder or a removal of the two-wheeler accessory from the holder and, in the securing state, to block the two-wheeler accessory against a removal from the holder when said two-wheeler accessory is received in the holder. In this respect, the pivot clips are each formed in at least two parts and comprise a first pivot arm, which is pivotably supported at the base body about a first pivot axis and which assumes a pivoted-out position in the releasing state and a pivoted-in position in the securing state, and a second pivot arm, which is pivotably supported at the base body about a second pivot axis and which assumes a pivoted-out position in the releasing state and a pivoted-in position in the securing state, wherein the first pivot axis and the second pivot axis are arranged closer to the same one of the two longitudinal sides of the contact surface than to the other.

### FIELD

The invention relates to a holder for a two-wheeler accessory, in particular for a two-wheeler lock, preferably for a jointed bar lock.

### BACKGROUND

Due to the typically comparatively restricted stowage space at a two-wheeler, it is advantageous to provide a separate holder for some accessories. In particular locks for securing the two-wheeler in the parked state always have to be carried along as a rule. If it is in this respect not a lock, for instance a frame lock, fixedly mounted to the two-wheeler, a holder can therefore be provided at the two-wheeler for a lock, or also for a different accessory carried along loosely.

The most important task of the holder in this respect is a reliable holding of the accessory received therein so that it cannot be lost, in particular during the ride, and above all does not put the safety of the rider at risk (e.g. if it were to fall out of the holder into the spokes of a wheel). It is, however, desirable in this respect if both the insertion of the accessory into the holder and the removal of the accessory from the holder is possible in a particularly simple manner. The holder should furthermore be as compact as possible to be able to be attached to the two-wheeler without hindering the rider.

It is known to fasten two-wheeler locks to a two-wheeler in that they are connected directly to a holder, i.e. they can only be released from the holder by unlocking by means of the respective key. For this purpose, the holder can, for example, simply provide an eyelet through which the lock is guided and is subsequently locked. While this kind of arrangement is particularly reliably secured against an accidental release, it is in particular not suitable for jointed bar locks (which can also be called folding locks). For unlike with a spiral lock, for instance, with a jointed bar lock, the jointed bars of the jointed bar lock could unfold in an uncontrolled manner if they are not held in some manner in the folded-together state, which could represent a risk during riding. In addition, such a connection of the lock to the two-wheeler is not comfortable to the extent that the lock has to be respectively locked for its stowing at the two-wheeler and has to be unlocked again before use. Operating the holder is, however, the more comfortable, the more fluid the movement routine on the insertion and removal of the lock into the holder or out of the holder can be.

It is to be preferred in this regard if the accessory to be held does not have to be separately locked or opened for its stowing at the two-wheeler. It is furthermore even more advantageous if the holder itself also does not have to be separately locked or opened but can rather be adjusted automatically or at least as independently as possible, in particular assisting a user of the holder, between a state that allows an insertion of the accessory into the holder or a removal of the accessory from the holder and a state in which the accessory received in the holder is blocked against a removal from the holder.

Holders for two-wheeler accessories, such as a two-wheeler lock, in particular for a jointed bar lock, are known that meet these requirements. Such holders, which are configured according to the preamble of claim 1, are described in DE 10 2016 104 798 A1 and have proven to be reliable.

However, these holders are only suitable for two-wheeler accessories of a limited width. For example, holders that are configured according to the embodiment shown in the figures of DE 10 2016 104 798 A1 are suitable for jointed bar locks whose width substantially results from the fact that they comprise six jointed bars, but not for corresponding jointed bar locks that comprise more jointed bars and are therefore wider. The reason for this results from the design of the holders mentioned. In addition to a base body, by which a contact surface is defined which the two-wheeler accessory contacts when it is held in the holder, said holders have two pivot clips, which each comprise a holding limb and a lever limb and which can be pivoted between a release position and a securing position; in the securing position, a respective tangential section of the holding limb in this respect extends over the contact surface and thereby blocks the jointed bar lock received in the holder from being removed from the holder, whereas, in the release position, the pivot clips are pivoted so far away from one another that the tangential sections leave the region above the contact surface and then have a distance from one another that is greater than the width of the jointed bar lock so that the jointed bar lock can be removed from the holder between the tangential sections. For a reliable securing of wider jointed bar locks, the tangential sections mentioned would have to be longer in order to extend over as many jointed bars as possible so that it is ruled out that the middle jointed bars of the jointed bar lock can leave the holder between the tangential sections; then, the pivot clips would, however, also have to be able to pivot further away from one another so that the distance between the tangential sections can become so large that the jointed bar lock is released for a removal from the holder in the release position. However, this is not possible without further ado since the pivotability of the pivot clips is bounded by the narrow clearance that is available to the lever limbs below the contact surface for a pivoting.

In general, the problem for holders according to the preamble of claim 1 is that, if they are to be suitable for comparatively wide two-wheeler accessories, their pivot clips must be able to grip around the two-wheeler accessories correspondingly widely and must consequently have a correspondingly large pivotability that is, however, limited due to an ideally compact design of the holder, in particular of its base body.

### SUMMARY

It is an object of the invention to provide a holder for a two-wheeler accessory, for example for a two-wheeler lock, in particular for a jointed bar lock, of the kind mentioned, said holder being reliable, compact and nevertheless also suitable for a comparatively wide two-wheeler accessory.

The object is satisfied by a holder having the features of claim 1. Advantageous embodiments result from the dependent claims, from the Figures and from the present description.

The holder is configured as a holder for a two-wheeler accessory, in particular for a two-wheeler lock, preferably for a jointed bar lock, and comprises a base body by which a contact surface is defined, said contact surface being bounded by two opposite longitudinal sides with respect to a transverse direction and being contacted by the two-wheeler accessory when it is received in the holder, and one or more pivot clips that are each arranged at one of the two longitudinal sides and that are adjustable between a releasing state and a securing state in order, in the releasing state, to enable a receiving of the two-wheeler accessory in the holder or a removal of the two-wheeler accessory from the holder and, in the securing state, to block the two-wheeler accessory against a removal from the holder when said two-wheeler accessory is received in the holder.

The base body thus in particular represents a static part of the holder, while the pivot clips are movable (relative to the base body). The holder can thus be configured to be fastened to the two-wheeler, in particular to a frame of the two-wheeler, with the base body. Furthermore, said contact surface for the placing against of the two-wheeler accessory is defined by the base body such that the accessory can be arranged in a stable manner, and in particular in a defined position, at the two-wheeler via the base body.

The contact surface can in this respect be configured as a surface at the base body. It can, however, also only be defined by the base body in that the latter has a (not necessarily areal and not necessarily continuous) structure against which the accessory can be placed. Such a structure can, for example, only have support points and/or support edges at which the accessory is supported when it is received in the holder. The contact surface can then be extrapolated from such support points and/or support edges. The contact surface is in this respect preferably continuous and at least substantially areal but does not have to be exactly planar, but can rather, for example, also have a specific curvature, in particular in parallel with and/or perpendicular to a longitudinal direction of the base body, or can be adapted in a specific manner to the shape of the two-wheeler accessory.

In a transverse direction, the contact surface is bounded by two opposite longitudinal sides. These longitudinal sides preferably have a straight course in each case. If the longitudinal sides do not have a straight course, they can each preferably be approximated by a straight line parallel to a longitudinal direction, wherein the longitudinal direction is perpendicular to said transverse direction. The contact surface can extend along this longitudinal direction. This is in particular to be understood as the surface available at the base body for the placing against of the two-wheeler accessory having a greater extent in the longitudinal direction than in said transverse direction. However, it is generally also conceivable that the contact surface has a greater extent in the transverse direction than in the longitudinal direction. The contact surface can furthermore be designed at least substantially symmetrically with respect to the longitudinal direction, i.e. with respect to an axis of symmetry in parallel with the longitudinal direction or with respect to a plane of symmetry in parallel with the longitudinal direction and at least substantially perpendicular to the contact surface. Preferably, the pivot clips are arranged such that they each flank (exactly) one of the longitudinal sides of the contact surface. This can in particular comprise that the respective pivot clip—at least in the securing state —extends around the respective longitudinal side.

When pivot clips are spoken of in the plural here or in the following, the one or the plurality of pivot clips present at the holder are thus meant. Consequently, as long as the number of pivot clips (e.g. two or more) is not expressly defined, only a single pivot clip can also be meant in each case despite the use of the plural.

The adjustability of the pivot clips enables (at least) two different defined states: In the releasing state, the two-wheeler accessory can be received in the holder or, if it is already received in the holder, can be removed from the holder; in the securing state, on the other hand, the pivot clips are set so that the two-wheeler accessory cannot be removed from the holder when it is received in the holder, but is prevented from being removed by the pivot clips. In the releasing state and in the securing state, the pivot clips or their components each assume a specific position or configuration. Therefore, the releasing state and the securing state can also be referred to as the release position or securing position or as the release configuration or securing configuration of the pivot clips or the holder.

In the securing state, the holder does not necessarily have to completely enclose the respective accessory. In particular, a locking of the holder, i.e. a separate securing of the pivot clips in the securing state in order to block them against an adjustment into the releasing state, is not absolutely necessary either. Rather, in the securing state, the pivot clips can only be arranged or aligned relative to the accessory received in the holder such that they counteract a movement of the accessory out of the holder, in particular away from the contact surface of the base body.

According to the invention, the pivot clips are each formed in at least two parts and comprise a first pivot arm, which is pivotably supported at the base body about a first pivot axis and which assumes a pivoted-out position (of the first pivot arm) in the releasing state and a pivoted-in position (of the first pivot arm) in the securing state, and a second pivot arm, which is pivotably supported at the base body about a second pivot axis and which assumes a pivoted-out position (of the second pivot arm) in the releasing state and a pivoted-in position (of the second pivot arm) in the securing state, wherein the first pivot axis and the second pivot axis are arranged closer to the same one of the two longitudinal sides of the contact surface than to the other. In particular, the second pivot axis is different from the first pivot axis in this respect. Due to the support at the base body, the two pivot axes are furthermore stationary, i.e. stationary with respect to the base body. Furthermore, the pivoted-out position and the pivoted-in position of the first pivot arm are different from one another; the pivoted-out position and the pivoted-in position of the second pivot arm are likewise different from one another.

The first pivot arm is preferably formed in one part; the second pivot arm is also preferably formed in one part. In particular, the first pivot arm and the second pivot arm can each be rigid in this respect. Furthermore, the first pivot arm and the second pivot arm are preferably formed separately from one another; in particular, they can be formed as separate components independently of one another. The pivot clips can furthermore each be formed by the first pivot arm and the second pivot arm; it can therefore be provided that each of the pivot clips do not comprise any further components separate from the first pivot arm and the second pivot arm.

The pivoted-out position assumed by the first pivot arm, which could also be referred to as the first pivoted-out position, and the pivoted-out position assumed by the second pivot arm, which could also be referred to as the second pivoted-out position, indeed correspond to one another in that they are each assumed in the releasing state, but can otherwise differ from one another despite the identical designation. Similarly, the pivoted-in position assumed by the first pivot arm, which could also be referred to as the first pivoted-in position, and the pivoted-in position assumed by the second pivot arm, which could also be referred to as the second pivoted-in position, indeed correspond to one another in that they are each assumed in the securing state, but can otherwise differ from one another despite the identical designation.

In contrast to the initially mentioned known holders, the pivot clips of the holders according to the invention are formed in two parts. As a result, on an adjustment of the respective pivot clip, the entire pivot clip is not pivoted as a single rigid body about a single pivot axis, but rather two parts of the respective pivot clips, namely the two pivot arms, are pivoted about two different pivot axes. This so-to-say corresponds to a division of the individual pivot axis of a single-piece pivot clip into two separate pivot axes, whereby the kinematics change advantageously on an adjustment of the pivot clip.

The first pivot axis can in this respect be arranged at least substantially where the pivot axis of a single-piece pivot clip would also be arranged so that the first pivot arm can also have a similar pivotability as a single-piece pivot clip would have. Since the second pivot axis is arranged offset in relation thereto, the second pivot arm can, however, have a pivotability that is advantageously adapted-in particular for the purpose of being able to pivot out comparatively far. However, the second pivot axis does not necessarily have to be far away from the first pivot axis for this purpose and is expediently arranged in the vicinity of the first pivot axis since the first pivot arm and the second pivot arm together continue to form a single pivot clip arranged at a respective one of the two longitudinal sides of the contact surface. For this reason, the first pivot axis and the second pivot axis are arranged at the same longitudinal side of the contact surface so that they are both closer to this longitudinal side than to the other longitudinal side of the contact surface that is opposite thereto.

The first pivot axis and the second pivot axis are preferably parallel to one another. In this respect, the pivot axes can in particular be oriented perpendicular to the transverse direction. Thus, the pivot axes can be parallel to said longitudinal direction and in particular to the longitudinal sides of the contact surface.

Furthermore, it may be expedient for the first pivot axis and the second pivot axis to be arranged on different sides of the contact surface with respect to a direction perpendicular to the contact surface. In particular, the first pivot axis can be arranged below a contact plane in which the contact surface lies or by which the contact surface, if it is uneven, can be approximated, and the second pivot axis can be arranged above this contact plane. A comparatively large pivotability compared to the first pivot arm can thereby be achieved for the second pivot arm.

So that the pivot clips can be adjustable as a whole even if they are formed from the pivot arms formed separately from one another, it is expedient for the pivot arms to be coupled to one another for a coordinated pivoting. According to an advantageous embodiment, the first pivot arm and the second pivot arm are coupled to one another such that, on a pivoting of the first pivot arm into its pivoted-in position, the second pivot arm is pivoted into its pivoted-in position and, on a pivoting of the second pivot arm into its pivoted-out position, the first pivot arm is pivoted into its pivoted-out position. Preferably, the first pivot arm and the second pivot arm cooperate directly with one another for the aforementioned coupling; for example, they can act directly on one another. In this regard, the coupling is therefore not an indirect coupling that is mediated via other elements.

Furthermore, it is preferred that no rigid coupling is provided, i.e. that the first pivot arm and the second pivot arm are not permanently fixedly connected to one another at a fixed point. For example, the coupling can be effected by a loose engaging into one another. In particular, it can be provided that the first pivot arm and the second pivot arm are generally releasable from one another despite the coupling. For example, the first pivot arm and the second pivot arm can be configured such that the coupling is only maintained due to the support of the pivot arms at the base body, but would be spontaneously released if the pivot arms were detached from the base body.

Due to the coupling, a pivoting in of the first pivot arm automatically also leads to a pivoting in of the second pivot arm and a pivoting out of the second pivot arm automatically also leads to a pivoting out of the second pivot arm. The securing state can thus be brought about by actuating the first pivot arm and the releasing state can be brought about by actuating the second pivot arm.

If the respective pivot clip is to be adjustable into both the securing state and the releasing state simply by actuating the second pivot arm, the coupling can also be more extensive. According to an advantageous further development of the above embodiment, the first pivot arm and the second pivot arm are coupled to one another such that, on a pivoting of the second pivot arm into its pivoted-in position, the first pivot arm is pivoted into its pivoted-in position.

Finally, according to a further advantageous further development of the above embodiment, the first pivot arm and the second pivot arm can (alternatively or—preferably—in addition to the above further development) be coupled to one another such that, on a pivoting of the second pivot arm into its pivoted-out position, the first pivot arm is pivoted into its pivoted-out position.

Overall, a kind of complete motion coupling can therefore be provided between the first pivot arm and the second pivot arm, as a result of which the two pivot arms are inevitably pivoted together, regardless of which of the two pivot arms is actuated. In particular, it can thereby be ensured that, when one of the two pivot arms assumes its pivoted-in position or its pivoted-out position, the other pivot arm also assumes its corresponding position. In this respect, a certain amount of play may be possible, in particular in positions between the pivoted-in position and the pivoted-out position. Preferably, however, the joint adjustment of the two pivot arms is at least largely free of play due to the aforementioned coupling.

According to a further advantageous embodiment, the pivoted-in position and the pivoted-out position of the first pivot arm differ by a first pivot angle that is smaller than a second pivot angle by which the pivoted-in position and the pivoted-out position of the second pivot arm differ. In this respect, the pivot angle is in each case only considered in terms of its magnitude. The pivot angle which the first pivot arm travels through on a pivoting from its pivoted-in position into its pivoted-out position is consequently in any case smaller in magnitude than the pivot angle which the second pivot arm travels through on a pivoting from its pivoted-in position into its pivoted-out position. Preferably, however, the pivot direction in which the first pivot arm is pivoted from its pivoted-in position into its pivoted-out position is also identical to the pivot direction in which the second pivot arm is pivoted from its pivoted-in position into its pivoted-out position.

The (at least) two-part design of the pivot clips not only makes it possible that the two pivot arms of a respective pivot clip are pivotable about different pivot axes, but also that different pivot angles can be realized about which the pivot arms can each be pivoted. Expediently, the first pivot arm can in this respect be pivoted from its pivoted-in position into its pivoted-out position (or vice versa) about a pivot angle that substantially corresponds to the pivot angle which a single-piece pivot clip would also have. However, the second pivot arm advantageously has a larger pivot angle in comparison thereto so that, on the one hand, it can reach far over the contact surface in order to also hold a comparatively wide accessory securely in the holder and, on the other hand, it can pivot out widely in order to still be able to clear the region above the contact surface for a removal of the accessory from the holder.

In this respect, it is advantageous if the first pivot angle amounts to at most 45°. Preferably, the first pivot angle lies in a closed interval of 15° to 35°, i.e. it amounts to at least 15° and at most 35°. In particular, the first pivot angle can amount to approximately 25°. Furthermore, it is advantageous if the second pivot angle amounts to more than 45°. Preferably, the second pivot angle lies in a closed interval of 50° to 70°, i.e. it amounts to at least 50° and at most 70°. The second pivot angle can in particular amount to approximately 60°.

According to a further advantageous embodiment, the first pivot arm has a lever limb and a coupling limb that each extend from a common transition section, at which said lever limb and said coupling limb merge into one another, to a respective end section, wherein the first pivot axis extends through the common transition section, and wherein the coupling limb has a coupling section via which the first pivot arm is coupled to the second pivot arm. In particular, the first pivot arm can be coupled to the second pivot arm via the coupling section in one of the ways described above, for example, at least such that, on a pivoting of the first pivot arm into its pivoted-in position, the second pivot arm is pivoted into its pivoted-in position and, on a pivoting of the second pivot arm into its pivoted-out position, the first pivot arm is pivoted into its pivoted-out position.

The aforementioned limbs (lever limb and coupling limb) are sections of the first pivot arm. In particular, the first pivot arm can be formed by these two limbs; the first pivot arm then has no sections that are not either part of the lever limb or part of the coupling limb. Said common transition section, at which the lever limb and the coupling limb merge into one another, can in this respect both be part of the lever limb and part of the coupling limb. Otherwise, the lever limb and the coupling limb are preferably mutually disjoint sections of the first pivot arm.

The first pivot clip is preferably rigid so that the lever limb and the coupling limb are rigidly arranged and aligned with respect to one another. As limbs, the lever limb and the coupling limb each have an elongate extent with respect to their cross-section perpendicular to the first pivot axis. In particular for the lever limb, possibly also for the coupling limb, the course of this extent from the common transition section to the respective end section is preferably at least substantially straight. However, the course can also be curved, in particular for the coupling limb, wherein it can be approximated by a straight line. In relation to their respective extent, the lever limb and the coupling limb are preferably oriented at an angle to one another. The angle which is in this respect enclosed by the lever limb and the coupling limb preferably amounts to at least 90° and can in particular lie in the closed interval of 100° to 120°.

The first pivot arm is preferably arranged such that the lever limb extends from the first pivot axis, which extends through the common transition section, under the contact surface, whereas the coupling limb flanks the respective longitudinal side of the contact surface and therefore, starting from the first pivot axis at the respective longitudinal side, extends through the contact plane already mentioned above in which the contact surface lies or through which the contact surface, if it is uneven, can be approached. This preferably applies both in the securing state and in the releasing state.

According to a preferred further development, the coupling section of the first pivot arm is arranged at the end section of the coupling limb of the first pivot arm. As a result, the coupling section has a comparatively large distance from the first pivot axis and consequently travels a comparatively large distance on the pivoting of the first pivot arm from the pivoted-in position into the pivoted-out position (or vice versa). This helps to ensure that, on a pivoting of the first pivot arm, the second pivot arm, which is coupled to the first pivot arm via the coupling section, can be pivoted to a greater extent than the first pivot arm.

The holder can comprise a spring apparatus that acts on the lever limb of the first pivot arm and that is configured to preload the first pivot arm on one side of a transition position into the pivoted-in position and on the other side of the transition position into the pivoted-out position. The transition position is in this respect a pivot position of the first pivot arm that lies between the pivoted-in position and the pivoted-out position. The spring apparatus can in particular be one or more compression springs, for example in the form of helical springs.

If the holder comprises two pivot clips, the spring apparatus is preferably effective between the lever limbs of the two first pivot arms of the two pivot clips. The spring apparatus can in this respect also be effective pairwise between the lever limbs of the first pivot arms of a respective two pivot clips of the holder. The fact that the spring apparatus is effective between two lever limbs in this respect in particular means that the spring apparatus is supported with respect to the action on the respective one of the two lever limbs at the other one of the two lever limbs.

According to a further advantageous embodiment, the second pivot arm has a coupling limb and a retaining limb that each extend from a common transition section, at which said coupling limb and said retaining limb merge into one another, to a respective end section, wherein the second pivot axis extends through the end section of the coupling limb, and wherein the coupling limb has a coupling section via which the second pivot arm is coupled to the first pivot arm. (The retaining limb can at least functionally correspond to the tangential section mentioned further above.) In particular, the second pivot arm can be coupled to the first pivot arm via the coupling section in one of the ways described further above, for example, at least such that, on a pivoting of the first pivot arm into its pivoted-in position, the second pivot arm is pivoted into its pivoted-in position and, on the pivoting of the second pivot arm into its pivoted-out position, the first pivot arm is pivoted into its pivoted-out position.

The coupling of the second pivot arm to the first pivot arm via the coupling section of the coupling limb of the second pivot arm can correspond to the coupling mentioned further above of the first pivot arm to the second pivot arm via the coupling section of the coupling limb of the first pivot arm. In this case, the first pivot arm and the second pivot arm are coupled to one another in that the coupling section of the coupling limb of the first pivot arm and the coupling section of the coupling limb of the second pivot arm are coupled to one another.

The aforementioned limbs (coupling limb and retaining limb) are sections of the second pivot arm. In particular, the second pivot arm can be formed by these two limbs; the second pivot arm then does not have any sections that are not either part of the coupling limb or part of the retaining limb. Said common transition section, at which the coupling limb and the retaining limb merge into one another, can in this respect both be part of the coupling limb and part of the retaining limb. Otherwise, the coupling limb and the retaining limb are preferably mutually disjoint sections of the second pivot arm.

The second pivot clip is preferably rigid so that the coupling limb and the retaining limb are rigidly arranged and aligned with respect to one another. As limbs, the coupling limb and the retaining limb each have an elongate extent with respect to their cross-section perpendicular to the second pivot axis. The course of this extent from the common transition section to the respective end section is in this respect preferably at least substantially straight in each case. In principle, however, the course can also be curved, wherein it can then be approximated by a straight line. In relation to their respective extent, the coupling limb and the retaining limb are preferably oriented at an angle to one another. The angle which is in this respect enclosed by the coupling limb and the retaining limb preferably lies in the closed interval of 85° to 105° and can in particular amount to approximately 90°.

The second pivot arm is preferably arranged such that, in the securing state, the coupling limb extends from the second pivot axis, which extends through its end section, in a direction at least substantially perpendicular to the contact surface to the common transition section and, in the securing state, the retaining limb extends from the common transition section in a direction at least substantially parallel to the contact surface up to and over the contact surface to its end section.

According to a preferred further development, the coupling section of the second pivot arm is arranged between the second pivot axis and the common transition section of the coupling limb of the second pivot arm. As a result, on a pivoting of the second pivot arm, the common transition section (and with it the retaining limb) travels a greater distance than the coupling section so that a pivot movement of the first coupling limb transmitted via the coupling section to the second pivot arm is advantageously amplified.

In the securing state, the retaining limb can areally contact the respective accessory received in the holder in order to secure it in the holder. For example, the retaining limb can, in a cross-section perpendicular to the second pivot axis, at least predominantly have a straight course of constant thickness so that, due to its extent along the second pivot axis, in particular along the aforementioned longitudinal direction, said retaining limb can substantially be configured as a flat strip of constant thickness. For an even more reliable cooperation of the retaining limb with the accessory, it can, however, also be expedient for the retaining limb to be structurally adapted to the accessory. In particular, the retaining limb can have an elongate web section that (at least in the securing state) projects from the rest of the retaining limb in the direction of the contact surface in order to engage into the two-wheeler accessory, in particular in a form-fitting manner. The elongate shape of the web section can in particular be aligned parallel to the second pivot axis. The web section can, for example, be provided to engage into a notch formed at the accessory in the securing state. If the two-wheeler accessory is a jointed bar lock, the web section can in particular be provided to engage into a notch-like region between two mutually adjoining jointed bars of the (folded-together) jointed bar lock in the securing state.

An advantageous further development with respect to embodiments in which, as described above, the first pivot arm and the second pivot arm each have a coupling limb with a coupling section is based on the fact that the coupling section of one of the two pivot arms is configured as a coupling groove and the coupling section of the other of the two pivot arms is configured as a coupling web, wherein, for said coupling, the coupling web engages into the coupling groove. Said coupling of the first pivot arm and the second pivot arm to one another can preferably be effected precisely, in particular exclusively, by this engagement.

In this respect, the coupling web can in particular extend parallel to the pivot axis about which the respective pivot arm, at whose coupling limb the coupling web is formed, can be pivoted. Equally, the coupling groove can in this respect in particular extend parallel to the pivot axis about which the respective pivot arm, at whose coupling limb the coupling groove is formed, can be pivoted. In a cross-section perpendicular to this pivot axis, the coupling section configured as a coupling groove can, for example, be fork-shaped or Y-shaped, wherein the coupling groove is formed by the intermediate space between the two prongs of the fork shape or branches of the Y shape.

Due to the aforementioned configuration of the two coupling sections, the depth of the engagement of the one coupling section into the other can be variable. In particular, the depth of the engagement can depend on the respective pivot position of the two pivot arms. For example, the coupling web can engage deeper into the coupling groove in the releasing state than in the securing state. The variable engagement depth in this respect enables a continuous coupling of the two pivot arms to one another in all pivot positions despite the different stationary pivot axes about which the first and the second pivot arm can be pivoted.

According to a further advantageous embodiment, the holder has at least one pair of two pivot clips that are each configured in the aforementioned manner. In other words, it applies for each of the two pivot clips of the at least one pair: that it is arranged at one of the two longitudinal sides of the contact surface and is adjustable between a releasing state and a securing state in order, in the releasing state, to enable a receiving of the two-wheeler accessory into the holder or a removal of the two-wheeler accessory from the holder and, in the securing state, to block the two-wheeler accessory against a removal from the holder when it is received in the holder; and in that they are formed in two parts and comprise a first pivot arm, which is pivotably supported at the base body about a first pivot axis and which assumes a pivoted-out position in the releasing state and a pivoted-in position in the securing state, and a second pivot arm, which is pivotably supported at the base body about a second pivot axis and which assumes a pivoted-out position in the releasing state and a pivoted-in position in the securing state, wherein the first pivot axis and the second pivot axis are arranged closer to the same one of the two longitudinal sides of the contact surface than to the other. Furthermore, both pivot clips of the at least one pair can be configured in accordance with the pivot clips of the embodiments described above. Preferably, it is provided that the second pivot arms of the two pivot clips of the respective pair do not touch one another both in the releasing state and in the securing state, i.e. that a distance between the second pivot arms, in particular between said retaining limbs of the second pivot arms, also remains in the securing state.

In the above embodiment, which has at least one pair of two pivot clips, it is further preferred that the two pivot clips of the at least one pair are arranged symmetrically to one another with respect to a mirror axis or mirror plane that is at least substantially perpendicular to the contact surface. As regards said mirror axis, the two pivot clips of the respective pair can have a rotational symmetry of 180°; the two pivot clips of the respective pair can be mirror-symmetrical with respect to said mirror plane. If the holder has a plurality of pairs of pivot clips, the pivot clips are then advantageously arranged symmetrically to one another in pairs. Said mirror axis is preferably oriented perpendicular to said longitudinal direction and/or to said transverse direction; said mirror plane is preferably oriented perpendicular to said transverse direction.

As a result of said symmetry, it can in particular be provided that all four pivot axes of the two pivot clips of the respective pair (i.e. the first pivot axis and the second pivot axis of the one pivot clip as well as the first pivot axis and the second pivot axis of the other pivot clip) are parallel to one another, preferably parallel to said longitudinal direction. However, the pivot clips preferably differ in terms of the pivot directions of their pivot arms. In particular, the pivot direction in which the first pivot arm of the one pivot clip can be pivoted from its pivoted-out position into its pivoted-in position can be just opposite to the pivot direction in which the first pivot arm of the other pivot clip can be pivoted from its pivoted-out position into its pivoted-in position, and the pivot direction in which the second pivot arm of the one pivot clip can be pivoted from its pivoted-out position into its pivoted-in position can be just opposite to the pivot direction in which the second pivot arm of the other pivot clip can be pivoted from its pivoted-out position into its pivoted-in position.

Preferably, the two pivot clips of a respective pair are not only arranged symmetrically to one another, but are designed symmetrically to one another in a corresponding manner, i.e. with respect to a mirror axis or mirror plane that is at least substantially perpendicular to the contact surface. The two pivot clips can therefore have a rotational symmetry about 180° with respect to the mirror axis or can be mirror-symmetrical with respect to the mirror plane. In particular, the two pivot clips can also be of identical design to one another.

As already mentioned above, the holder can comprise said spring apparatus that is active between the lever limbs of the first pivot arms of the two pivot clips of a respective pair.

In addition or alternatively thereto, the first pivot arms of the two pivot clips can each have an entrainer, wherein the entrainers of the two pivot arms cooperate such that, in particular loosely engage into one another such that, on an adjustment of one of the two pivot clips into the releasing state or into the securing state, the other of the two pivot clips is likewise adjusted into the releasing state or into the securing state. In particular, the entrainers can cooperate such that, on an adjustment of the first pivot arm of one of the two pivot clips, the first pivot arm of the other of the two pivot clips is adjusted by the same amount in the opposite direction. In particular, the entrainers can each be formed at the lever limb of the first pivot arm of the respective pivot clip, preferably at said end section of the lever limb. The entrainers can, for example, each have at least one prolongation projecting radially with respect to the first pivot axis, wherein the radial prolongation of one of the two pivot clips acts on the entrainer of the other of the two pivot clips on an adjustment into the releasing state and the radial prolongation of the other of the two pivot clips acts on the entrainer of the one of the two pivot clips on an adjustment into the securing state. In this respect, the mutual action in particular in each case takes place in the circumferential direction with respect to the first pivot axis of the respective pivot clips. The prolongations can in this respect engage into one another like fingers or like segments of two toothed wheels.

Furthermore, the holder can comprise (preferably for each pair of two pivot clips in each case) a jacket element which is formed separately from the two pivot clips, in particular separately from the first pivot arms and second pivot arms of the two pivot clips, and by which said spring apparatus active between the two pivot clips of the respective pair and/or said mutually cooperating entrainers of the two pivot clips is/are at least partly enclosed. The jacket element can, for example, serve to secure the spring apparatus against a release from the pivot clips and/or to secure the entrainers against a release from one another, and can thus ensure the cooperation of the entrainers.

Furthermore, the jacket element can act as a release section that, in the pivoted-out position (and preferably also in said transition position), but not in the pivoted-in position of the first pivot arms of the two pivot clips, extends from below the contact surface through the contact surface and thereby projects beyond the contact surface in the direction away from the base body. As a result, the release section is acted on by the two-wheeler accessory in the releasing state when inserting the respective two-wheeler accessory into the holder and placing the two-wheeler accessory against the contact surface so that the first pivot arms of the two pivot clips are each pivoted about the first pivot axis in the direction of their pivoted-in position. If the spring apparatus is provided, the first pivot arms are furthermore, form the exceeding of the transition position, preloaded into the pivoted-in position and are consequently pivoted by the spring apparatus up to and into the pivoted-in position. The holder is thereby almost automatically adjusted into the securing state by the insertion of the two-wheeler accessory.

The named object of the invention is further satisfied by a two-wheeler accessory, in particular a two-wheeler lock, preferably a jointed bar lock, having a holder according to the invention that is configured to be suitable for the two-wheeler accessory. In this respect, the holder can in particular be configured in accordance with any one of the embodiments described above.

### BRIEF DESCRIPTION OF THE DRAWINGS

The invention will be explained in more detail in the following only by way of example with reference to the Figures.

FIG. 1 shows, in a perspective representation, an embodiment of a holder according to the invention for a jointed bar lock, in which holder a jointed bar lock is received, in the securing state;

FIG. 2 shows the same embodiment again in the securing state, but without the jointed bar lock and from a different angle of view;

FIG. 3 shows a part of the same embodiment, in particular its pivot clips;

FIG. 4 shows a jacket element of the same embodiment;

FIG. 5 shows a cross-section through the same embodiment in the securing state with the jointed bar lock received in the holder; and

FIG. 6 shows a cross-section through the same embodiment in the releasing state without the jointed bar lock.

### DETAILED DESCRIPTION

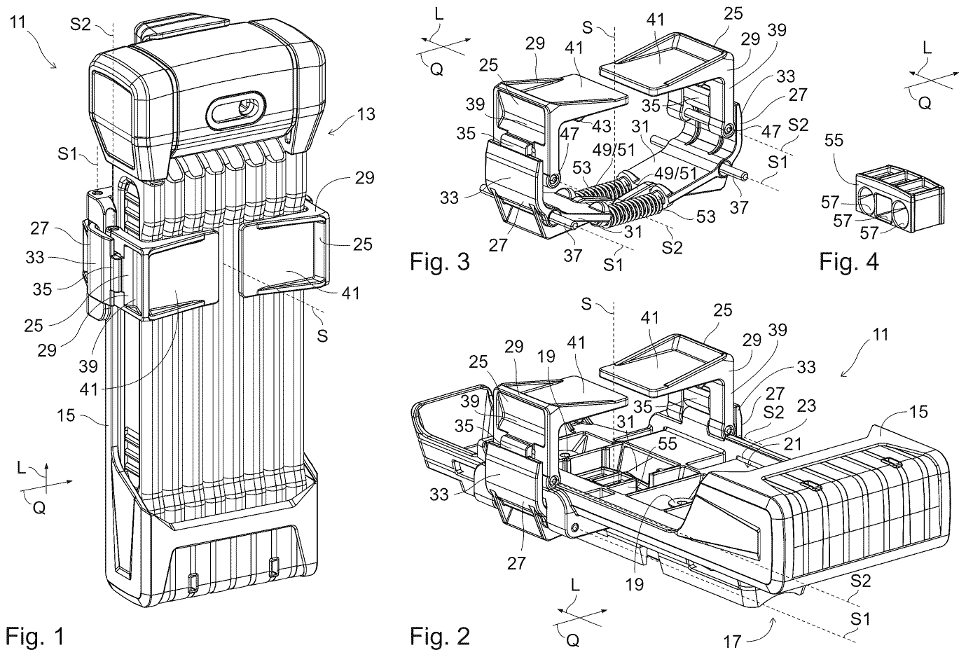

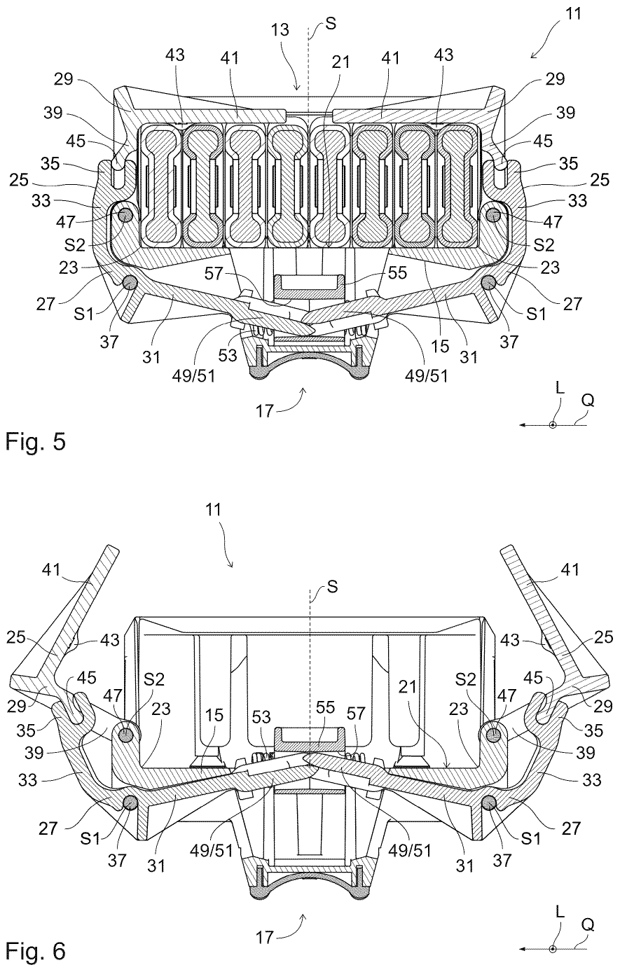

A holder 11 according to an exemplary embodiment of the invention is shown in the Figures. The holder 11 serves to hold a two-wheeler lock, namely a jointed bar lock 13, at a two-wheeler. For this purpose, the holder 11 is configured to receive the jointed bar lock 13. The holder 11 with the jointed bar lock 13 received therein is shown in FIGS. 1 and 5. In this regard, FIGS. 1 and 5 also show an embodiment of a two-wheeler lock 13 that, according to the invention, comprises a holder 11 suitably configured for the two-wheeler lock 13.

The holder 11 has a base body 15 that is configured to be fastened to a two-wheeler, in particular to a frame tube of the two-wheeler. For this purpose, an underside 17 of the base body 15 is curved accordingly. The fastening of the base body 15 to the frame tube can, for example, take place by means of screws 19 (cf. FIG. 2) that are screwed through the base body 15 into the frame tube or into threaded bushings fastened to the frame tube.

The base body 15 extends in a longitudinal direction L and has, opposite the underside 17, a contact surface 21 which the jointed bar lock 13 contacts when it is received in the holder 11. The contact surface 21 likewise extends in the longitudinal direction L, on the one hand, and is bounded by two opposite longitudinal sides 23 with respect to a transverse direction Q perpendicular to the longitudinal direction L, on the other hand. A respective pivot clip 25 of the holder 11 is arranged at each of the two longitudinal sides 23. The holder 11 thereby has a pair of the two pivot clips 25. The two pivot clips 25 are of identical design to one another and are arranged symmetrically to one another with respect to a mirror axis S that is oriented perpendicular to the contact surface 21 and that crosses the contact surface 21 centrally between the two longitudinal sides 23.

The pivot clips 25 are each formed in two parts and each comprise a first pivot arm 27 and a second pivot arm 29. In the following, the configuration of the pivot clips 27 is described with reference to only one of the two pivot clips 27, wherein the description applies to both pivot clips due to the identical design.

The first pivot arm 27 has a lever limb 31 and a coupling limb 33. The lever limb 31 and the coupling limb 33 extend at an angle to one another from a common transition section, at which the lever limb 31 and the coupling limb 33 merge into one another, to a respective end section. At its end section, the coupling limb 33 has a coupling section 35 configured as a coupling groove (cf. the cross-sectional representations of FIGS. 5 and 6). The angle between the lever limb 31 and the coupling limb 33 amounts to approximately 110° or 115°.

The first pivot arm 27 is pivotably supported at the base body 15 about a first pivot axis S1. The support in this respect takes place via a first bearing pin 37 that extends through leadthroughs formed at the base body 15 and through a leadthrough formed in said transition section through the first pivot arm 27 (cf. in particular FIG. 3).

The second pivot arm 29 comprises a coupling limb 39 and a retaining limb 41. The coupling limb 39 and the retaining limb 41 extend at an angle to one another from a common transition section, at which the coupling limb 39 and the retaining limb 41 merge into one another, to a respective end section. Between the transition section and its end section, the coupling limb 39 has a coupling section 45 configured as a coupling web (cf. the cross-sectional representations of FIGS. 5 and 6). The angle between the coupling limb 39 and the retaining limb 41 amounts to approximately 90°.

The second pivot arm 29 is pivotably supported at the base body 15 about a second pivot axis 32. The support in this respect takes place via a second bearing pin 47 that extends through a leadthrough formed at the base body 15 and through leadthroughs formed in said end section of the coupling limb 39 through the second pivot arm 29 (cf. in particular FIG. 3).

The first pivot axis S1 and the second pivot axis S2 are in this respect aligned parallel to one another and to said longitudinal direction L and are arranged in the region of the respective longitudinal side 23 at which the pivot clip 25 is arranged. As a result, both the first pivot axis S1 and the second pivot axis S2 are closer to this longitudinal side 23 than to the longitudinal side 23 of the contact surface 21 that is opposite thereto.

The first pivot axis S1 is arranged below a contact plane in which the contact surface 21 lies or through which the contact surface 21 can at least be approached. The lever limb 31 of the first pivot arm 27 can thereby extend below the contact surface 21, while the coupling limb 33 of the first pivot arm 27, which is angled relative to the lever limb 31, extends laterally to the contact surface 21 through said contact plane and flanks the contact surface 21 in this regard.

The second pivot axis S2, on the other hand, is arranged above said contact plane so that the two pivot axes S1, S2 are arranged on different sides of the contact surface 21 with respect to a direction perpendicular to the contact surface 21. As a result, the coupling limb 39 of the second pivot arm 29 can be arranged at least approximately in extension of the coupling limb 33 of the first pivot arm 27 laterally to the contact surface 21, while the retaining limb 41, which is angled relative to the coupling limb 39, can extend up to and over the contact surface 21. In this way, the retaining limb 41 can contact the jointed bar lock 13 depending on its pivot position in order to secure said jointed bar lock 13 in the holder 11. The retaining limb 41 furthermore has an elongate web section 43 (cf. in particular FIG. 6) that projects from the retaining limb 41 in the direction of the contact surface 21 in order to engage into a notch-like region between two consecutive jointed bars of the jointed bar lock 13 received in the holder 11 for a further improved securing of the jointed bar lock 13.

Due to the pivotable support about the respective pivot axis S1, S2, the first pivot arm 27 and the second pivot arm 29 can assume the pivoted-in position shown in FIGS. 1 to 3 and 5, on the one hand, and the pivoted-out position shown in FIG. 6, on the other hand, and can be pivoted between these positions. In this respect, in all the pivot positions between the pivoted-in position and the pivoted-out position (including these two positions), the coupling section 45 of the second pivot arm 29, which is configured as a coupling web, engages into the coupling section 35 of the first pivot arm 27, which is configured as a coupling groove, to different depths depending on the pivot position (cf. the cross-sectional representations of FIGS. 5 and 6).

This leads to a coupling of the first pivot arm 27 and the second pivot arm 29 with one another, said coupling being of such a kind that, on a pivoting of the first pivot arm 27 or the second pivot arm 29 into the pivoted-in position or into the pivoted-out position, the respective other pivot arm 27 or 29 is pivoted into its corresponding pivot position. If one of the two pivot arms 27, 29 is pivoted into its pivoted-in position, the other is therefore also pivoted into its pivoted-in position and, if one of the two pivot arms 27, 29 is pivoted into its pivoted-out position, the other is also pivoted into its pivoted-out position.

If, as shown in FIGS. 1 to 3 and 5, the first pivot arm 27 and the second pivot arm 29 are in their respective pivoted-in position, this corresponds to a securing state in which the jointed bar lock 13 received in the holder 11 is blocked by the pivot clips 25 against a removal from the holder 11; if, on the other hand, as shown in FIG. 6, the first pivot arm 27 and the second pivot arm 29 are in their respective pivoted-out position, this corresponds to a releasing state in which a receiving of the jointed bar lock 13 in the holder 11 and a removal of the jointed bar lock 13 from the holder 11 are possible. Due to the aforementioned coupling of its two pivot arms 27, 29, the pivot clip 25 can be easily adjusted between the releasing state and the securing state.

The pivot angle by which the pivoted-in position and the pivoted-out position of the first pivot arm 27 differ from one another is—as a result of the described position of the pivot axes S1, S2 and their arrangement at the pivot arms 27, 29 and the arrangement of the coupling sections 35, 45 at the pivot arms 27, 29—smaller than the pivot angle by which the pivoted-in position and the pivoted-out position of the second pivot arm 29 differ from one another. In the embodiment shown, the pivot angle of the first pivot arm 27 amounts to approximately 45°, while the pivot angle of the second pivot arm 29 amounts to approximately 60°. In this way, the first pivot arm 27 can be pivoted about a comparatively small angle, limited by the space available below the contact surface 21 for the lever limb 31, while the second pivot arm 29 is simultaneously pivoted about a comparatively large angle as a result of the coupling to the first pivot arm 27. This makes it possible that the retaining limb 41 can be formed comparatively long so that, in its pivoted-in position (securing state), it can reliably secure the jointed bar lock 13, which is comparatively wide due to its eight jointed bars, in the holder 11, and can nevertheless be pivoted out so far in its pivoted-out position (releasing state) that it laterally leaves the space above the contact surface 21 and thereby enables the insertion or removal of the jointed bar lock 13.

Not only the two pivot arms 27, 29 of a respective pivot clip 25 are coupled to one another, but also the two pivot clips 25 of said pair are coupled to one another. For this purpose, an entrainer 49 is formed at said end section of the lever limb 31 of the first pivot arm 27 and has at least one radial prolongation 51 with respect to the first pivot axis S1 in each case. The lever limbs 31 of the first pivot arms 27 of the two pivot clips 25 in this respect extend so far towards one another below the contact surface 21 that the at least one radial prolongation 51 formed at the one pivot clip 25 and the at least one radial prolongation 51 formed at the other pivot clip 25 engage loosely into one another such that, on an adjustment of one of the two pivot clips 25 into the releasing state or into the securing state, the other of the two pivot clips 25 is likewise adjusted into the releasing state or into the securing state.

The holder furthermore comprises a spring apparatus 53 that comprises two compression springs in the form of two helical springs and acts on said end sections of the lever limbs 31 of the first pivot arms 27 of the two pivot clips 25 and thereby pushes them away from one another (cf. in particular FIG. 3). In this respect, these end sections have the smallest distance, at which the helical springs are compressed the most and therefore exert the greatest spring force, in a transition position, not shown, of the first pivot arms 27, in which transition position the end sections and the first pivot axes S1 are arranged in a line. On the one side of this transition position, the first pivot arms 27 are thus preloaded by the spring apparatus 53 into their pivoted-out position; as a result of the coupling via the coupling sections 35, 45, the second pivot arms 29 are likewise preloaded into their pivoted-out position and the pivot clips 25 as a whole are preloaded into the releasing state; on the other side of the transition position, on the other hand, the first pivot arms 27 are preloaded by the spring apparatus 53 into their pivoted-in position; as a result of the coupling via the coupling sections 34, 35, the second pivot arms 29 are likewise preloaded into their pivoted-in position and the pivot clips 25 as a whole are preloaded into the securing state.

Furthermore, the holder 11 for the aforementioned pair of two pivot clips 25 comprises a jacket element 55 that is shown separately in FIG. 4. The jacket element 55 is formed separately from the two pivot clips 25, is cuboid-shaped and is provided to at least partly enclose said entrainers 49 with their radial prolongations 51 as well as the spring apparatus 53. For this purpose, the jacket element 55 has three passages 57 that extend through the jacket element 55 along said transverse direction Q and that are arranged adjacent to one another along said longitudinal direction L. The radial prolongations 51 of the entrainers 49 of the two pivot clips 25 extend from both sides into the middle one of these passages 57 so that they cooperate within the jacket element 55; a respective one of the compression springs of the spring apparatus 53 extends through the two outer passages 57. In this way, the jacket element 55 can ensure a reliable cooperation of the entrainers 49 and can secure the springs of the spring apparatus 53 against releasing from the pivot clips 25.

In addition, the jacket element 55 functions as a release section that, in the pivoted-out position (and preferably also in said transition position), but not in the pivoted-in position of the first pivot arms 27 of the two pivot clips 25, extends from below the contact surface 21 through the contact surface 21 and thereby projects beyond the contact surface 21 in the direction away from the base body 15 (cf. FIG. 6). As a result, in the releasing state, on the insertion of the jointed bar lock 13 into the holder 11, the jacket element 55 is acted on by the contact of the jointed bar lock 13 with the contact surface 21 so that the first pivot arms 27 of the two pivot clips 25 are each pivoted about the first pivot axis S1 in the direction of the pivoted-in position. From the exceeding of the transition position, the first pivot arms 27 are then furthermore pivoted by the spring apparatus 53 up to and into the pivoted-in position. The holder 11 is thereby almost automatically adjusted into the securing state by the insertion of the jointed bar lock 13.

Overall, the holder 11 can thus be comfortably operated. In this respect, the holder 11 is also suitable for comparatively wide jointed bar locks 13 (or another comparatively wide two-wheeler accessory) without this leading to an impairment of the ease of use or the reliability. In this respect, the suitability for comparatively wide two-wheeler accessories is in particular achieved by the two-part design of the pivot clips 25 with two pivot axes S1, S2 that are different but that are arranged at the same longitudinal side 23 of the contact surface 21.

### REFERENCE NUMERALS

11 holder
13 two-wheeler accessory in the form of a jointed bar lock
15 base body
17 lower side of the base body
19 screw
21 contact surface
23 longitudinal side of the contact surface
25 pivot clip
27 first pivot arm
29 second pivot arm
31 lever limb of the first pivot arm
33 coupling limb of the first pivot arm
35 coupling section configured as a coupling groove
37 first bearing pin
39 coupling limb of the second pivot arm
41 retaining limb of the second pivot arm
43 web section
45 coupling section configured as a coupling web
47 second bearing pin
49 entrainer
51 radial prolongation
53 spring apparatus
55 jacket element
57 passage
L longitudinal direction
Q transverse direction
S mirror axis
S1 first pivot axis
S2 second pivot axis

1. A holder for a two-wheeler accessory, said holder comprising
a base body by which a contact surface is defined, said contact surface being bounded by two opposite longitudinal sides with respect to a transverse direction and being contacted by the two-wheeler accessory when it is received in the holder, and
one or more pivot clips that are each arranged at one of the two longitudinal sides and that are adjustable between a releasing state and a securing state in order, in the releasing state, to enable a receiving of the two-wheeler accessory in the holder or a removal of the two-wheeler accessory from the holder and, in the securing state, to block the two-wheeler accessory against a removal from the holder when said two-wheeler accessory is received in the holder,
wherein the pivot clips are each formed in at least two parts and comprise a first pivot arm, which is pivotably supported at the base body about a first pivot axis and which assumes a pivoted-out position in the releasing state and a pivoted-in position in the securing state, and a second pivot arm, which is pivotably supported at the base body about a second pivot axis and which assumes a pivoted-out position in the releasing state and a pivoted-in position in the securing state,
and wherein the first pivot axis and the second pivot axis are arranged closer to the same one of the two longitudinal sides of the contact surface than to the other.

2. The holder according to claim 1,
wherein the first pivot axis and the second pivot axis are parallel to one another.

3. The holder according to claim 1,
wherein the first pivot axis and the second pivot axis are arranged on different sides of the contact surface with respect to a direction perpendicular to the contact surface.

4. The holder according to claim 1,
wherein the first pivot arm and the second pivot arm are coupled to one another such that, on a pivoting of the first pivot arm into its pivoted-in position, the second pivot arm is pivoted into its pivoted-in position and, on a pivoting of the second pivot arm into its pivoted-out position, the first pivot arm is pivoted into its pivoted-out position.

5. The holder according to claim 4,
wherein the first pivot arm and the second pivot arm are coupled to one another such that, on a pivoting of the first pivot arm into its pivoted-out position, the second pivot arm is pivoted into its pivoted-out position and/or, on a pivoting of the second pivot arm into its pivoted-in position, the first pivot arm is pivoted into its pivoted-in position.

6. The holder according to claim 1,
wherein the pivoted-in position and the pivoted-out position of the first pivot arm differ by a first pivot angle that is smaller than a second pivot angle by which the pivoted-in position and the pivoted-out position of the second pivot arm differ.

7. The holder according to claim 6,
wherein the first pivot angle amounts to most 45° and/or the second pivot angle amounts to more than 45°.

8. The holder according to claim 6,
wherein the first pivot angle lies in the closed interval of 15° to 35° and/or the second pivot angle lies in the closed interval of 50° to 70°.

9. The holder according to claim 6,
wherein the first pivot angle amounts to approximately 25° and/or the second pivot angle amounts to approximately 60°.

10. The holder according to claim 1,
wherein the first pivot arm has a lever limb and a coupling limb that each extend from a common transition section, at which said lever limb and said coupling limb merge into one another, to a respective end section,
wherein the first pivot axis extends through the common transition section,
and wherein the coupling limb has a coupling section via which the first pivot arm is coupled to the second pivot arm.

11. The holder according to claim 10,
wherein the coupling section of the first pivot arm is arranged at the end section of the coupling limb of the first pivot arm.

12. The holder according to claim 1,
wherein the second pivot arm has a coupling limb and a retaining limb that each extend from a common transition section, at which said coupling limb and said retaining limb merge into one another, to a respective end section,
wherein the second pivot axis extends through the end section of the coupling limb, and wherein the coupling limb has a coupling section via which the second pivot arm is coupled to the first pivot arm.

13. The holder according to claim 12,
wherein the coupling section of the second pivot arm is arranged between the second pivot axis and the common transition section of the coupling limb of the second pivot arm.

14. The holder according to claim 12,
wherein the retaining limb has an elongate web section that projects from the rest of the retaining limb towards the contact surface in order to engage into the two-wheeler accessory.

15. The holder according to claim 10,
wherein the second pivot arm has a coupling limb and a retaining limb that each extend from a common transition section, at which said coupling limb and said retaining limb merge into one another, to a respective end section,
wherein the second pivot axis extends through the end section of the coupling limb,
wherein the coupling limb has a coupling section via which the second pivot arm is coupled to the first pivot arm,
wherein the coupling section of one of the two pivot arms is configured as a coupling groove and the coupling section of the other of the two pivot arms is configured as a coupling web,
and wherein the coupling web engages into the coupling groove for said coupling.

16. The holder according to claim 1,
which has at least one pair of two pivot clips that are each configured in the manner mentioned,
wherein the two pivot clips are arranged symmetrically to one another with respect to a mirror axis or mirror plane that is at least substantially perpendicular to the contact surface.

17. The holder according to claim 1,
wherein the two-wheeler accessory is a two-wheeler lock.

18. A two-wheeler accessory comprising a holder, said holder comprising
a base body by which a contact surface is defined, said contact surface being bounded by two opposite longitudinal sides with respect to a transverse direction and being contacted by the two-wheeler accessory when it is received in the holder, and
one or more pivot clips that are each arranged at one of the two longitudinal sides and that are adjustable between a releasing state and a securing state in order, in the releasing state, to enable a receiving of the two-wheeler accessory in the holder or a removal of the two-wheeler accessory from the holder and, in the securing state, to block the two-wheeler accessory against a removal from the holder when said two-wheeler accessory is received in the holder,
wherein the pivot clips are each formed in at least two parts and comprise a first pivot arm, which is pivotably supported at the base body about a first pivot axis and which assumes a pivoted-out position in the releasing state and a pivoted-in position in the securing state, and a second pivot arm, which is pivotably supported at the base body about a second pivot axis and which assumes a pivoted-out position in the releasing state and a pivoted-in position in the securing state,
wherein the first pivot axis and the second pivot axis are arranged closer to the same one of the two longitudinal sides of the contact surface than to the other, and wherein the holder is configured to be suitable for the two-wheeler accessory.

19. The two-wheeler accessory according to claim 18,
wherein the two-wheeler accessory is a two-wheeler lock.
